(19) United States
(12) Patent Application Publication
(10) Pub. No.: US 2008/0076303 A1
(43) Pub. Date: Mar. 27, 2008

(54) Electrical connector

(75) Inventor: Li-Zhi Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/901,898

(22) Filed: Sep. 19, 2007

(30) Foreign Application Priority Data
Sep. 22, 2006 (CN) 200620077820.1

(51) Int. Cl. H01R 24/04

(52) U.S. Cl. 439/668

(57) ABSTRACT

An electrical connector (100) comprises an insulative housing (1) defining a receiving cavity (121) therein and a slot (13) thereon, at least one terminal arranged in the housing, a sleeve (4) retained in an inside of the receiving cavity and a clip (5) inserted into the slot (13) to lock the sleeve (4).

### BACKGROUND OF THE INVENTION

1. Field of the Invention

The present invention relates to an electrical connector, and more particularly to an electrical connector with an inner sleeve therein.

2. Description of Related Art

A conventional audio jack or power connector generally includes an insulative housing defining a mating portion with a plug insertion columnar hole thereof and a sleeve assembled inside the columnar hole, which acts as a grounding contact to release electrostatic charge and completes the electrical connection. In common use, a counter connector is used to be inserted into the mating portion to establish electrical engagement and pulled out to cutoff the engagement. However, during the iterative operating process, the inner sleeve may break off the mating portion thereby resulting in disconnection of the electrical connector with the counter connector. Therefore, a new design can solve the problem is required.

### SUMMARY OF THE INVENTION

An object of the present invention is to provide an electrical connector with a clip to prevent an inner sleeve from breaking off the electrical connector.

In order to achieve above-mentioned objects, an electrical connector comprises an insulative housing defining a receiving cavity therein and a slot thereon, at least one terminal arranged in the housing, a sleeve retained in an inside of the receiving cavity and a clip inserted into the slot to lock the sleeve.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a front, left perspective view of an electrical connector in accordance with the present invention;

FIG. 2 is an exploded perspective view of the electrical connector of FIG. 1;

FIG. 3 is an exploded perspective view of the electrical connector from another view;

FIG. 4 is a cross-sectional view of the electrical connector taken along line 4-4 of FIG. 1; and

FIG. 5 is a cross-sectional view of the electrical connector taken along line 5-5 of FIG. 1.

### DETAILED DESCRIPTION OF THE INVENTION

Reference will now be made to the drawing figures to describe the preferred embodiment of the present invention in detail.

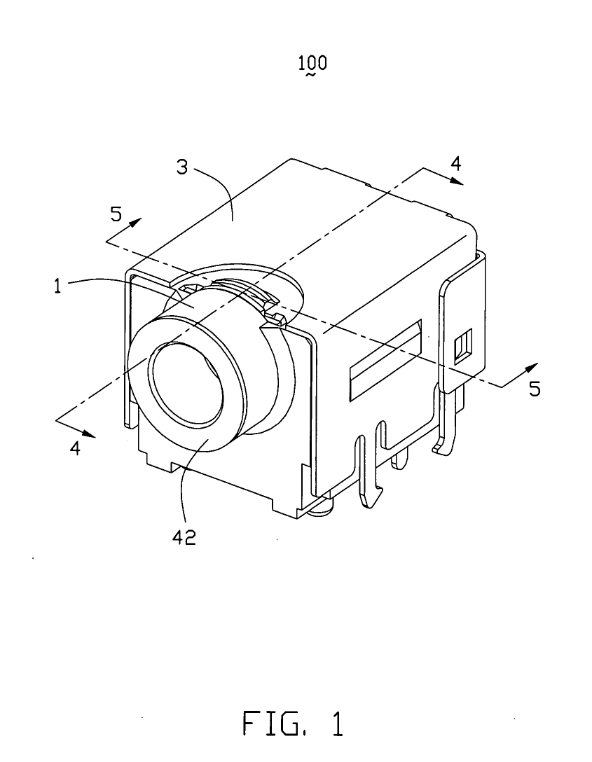

Referring to FIG. 1, an electrical connector 100 according with the present invention comprises an insulative housing 1, a plurality of terminals in the housing and a shield 3 surrounding an outer surface of the housing.

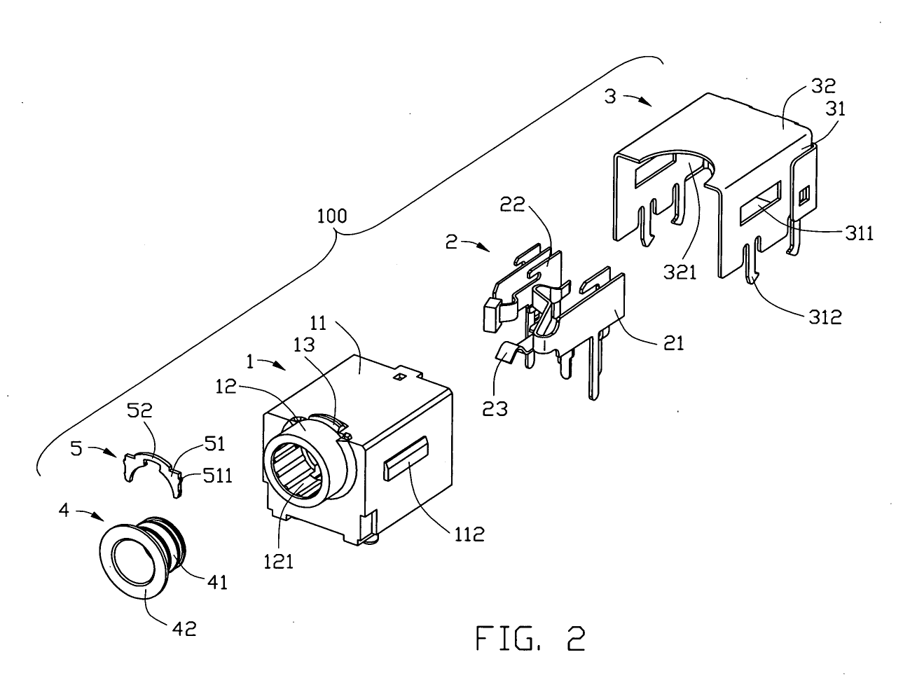

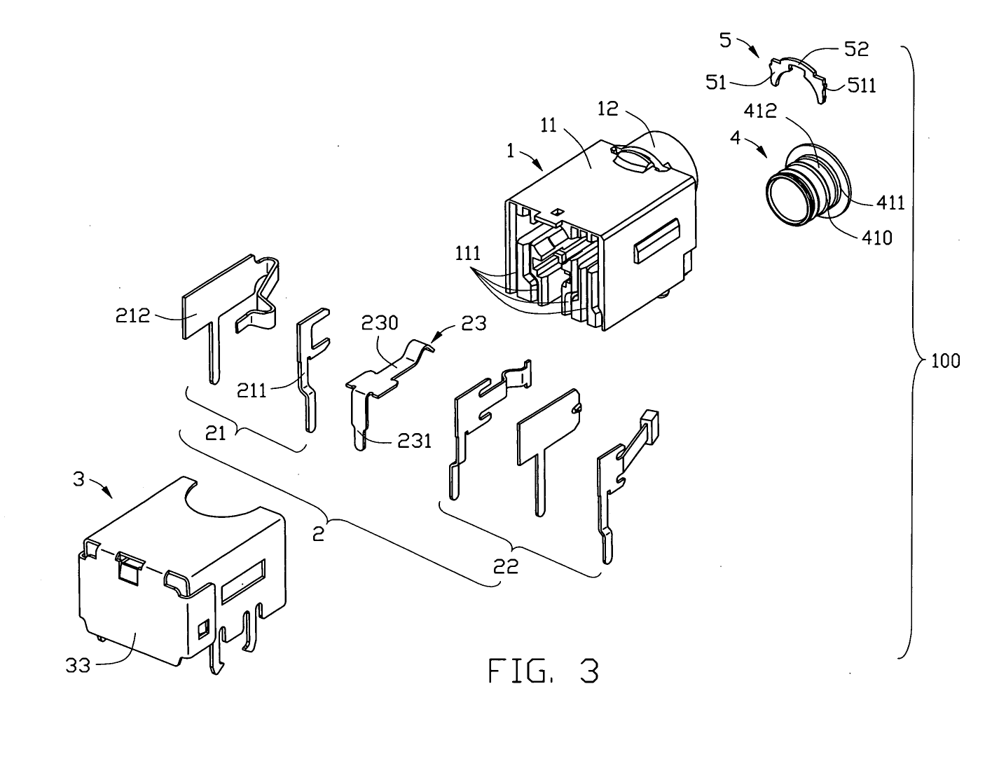

Referring to FIGS. 2 and 3, the insulative housing 1 comprises a main body 11 in shape of a rectangular block and a cylindrical mating portion 12 projected integrally from a front side of the main body 11. A plug insertion space or receiving cavity 121 is defined through the front side of the mating portion 12 and the back of the main body 11 along a front-to-back direction to allow insertion of a plug (not shown). A slot 13 is defined in an interface between the mating portion 12 and the main body 11 and extends downwardly from the upper surface of the main body 11 to communicate with the plug insertion space 121. A plurality of terminal grooves 111 is defined at the rear wall of the housing and extends forwardly along a back-to-front direction at sides of the insertion space. The terminals 2 are inserted into the terminal grooves 111 from rear of the housing 1.

In this embodiment, the connector sets three groups of terminals, a first terminal group 21 comprising a moveable terminal 211 and a fixing terminal 212, a second terminal group 22 comprising three terminals cooperating with each other, and a third terminal group 23 comprising one single terminal. The assemble process and work theory of the terminal is conventional, which can refer to U.S. Pat. No. 7,094,088.

Referring to FIGS. 2 and 3, a sleeve 4 made from metal material comprises a base portion 41 received in the mating portion 12. An annular groove 412 is provided between two annular protrusions 410, 411 along an outer perimeter surface at one end of the sleeve 4. An annular blocking portion 42 is formed at front distal end opposite to said end of the sleeve. The sleeve 4 is inserted into the mating portion 12 along the front-to-back direction, with the blocking portion 42 being blocked by the front surface of the mating portion and the annular groove 412 aligned with the slot 13 defined on the mating portion 12.

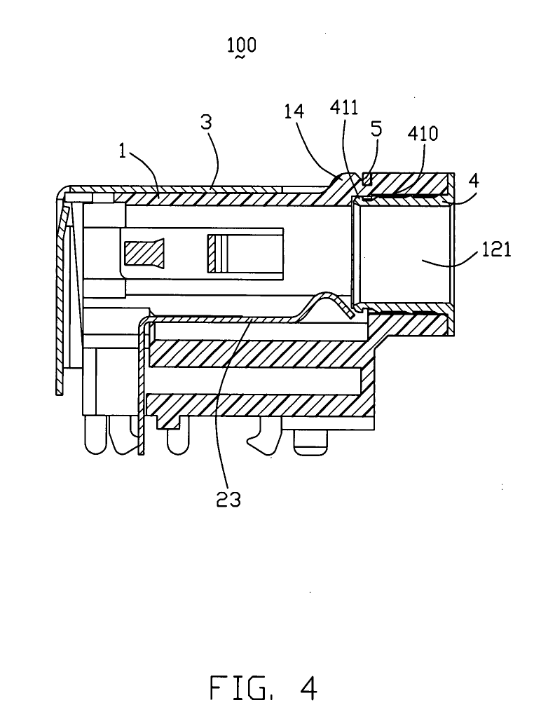

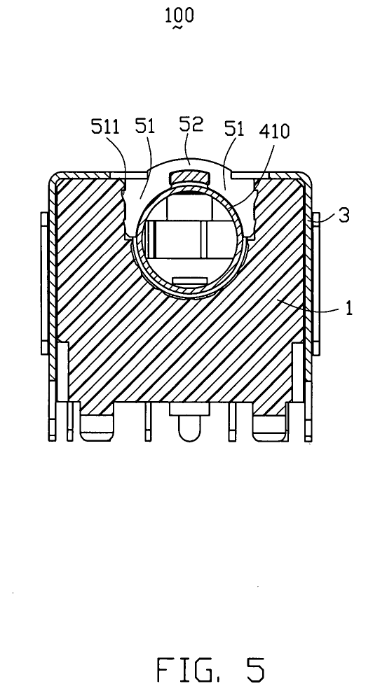

A metal clip 5 in shape of an arch is separately formed to retain the sleeve 4. The clip 5 comprises a connecting beam 52 and a pair of clipping portions 51 arranged symmetrically at opposite ends of the connecting beam 52. The clipping portions 51 are provided with an arc inside edge, which corresponds with the annular groove 412. At two sides of the contacting beam 52, a plurality of tips 511 is provided to retain the clip 5 in the housing. Referring to FIGS. 4 and 5, the clip 5 is inserted into the housing 1 through the slot 13 vertical to the sleeve 4. The clipping portions 51 are foisted into the annular groove 412 and blocked by the two protrusions 410, 411. The connecting beam 52 of the clip 5 projects out of the slot 13, therefore the clip 5 can be easily drawn out. A tuber 14 is formed on the housing at the back of the slot 13 to further retain the connecting beam 52 of the clip 5. The metal clip 5 fixes the sleeve 4 in the mating portion 12 smoothly, and prevents it from moving forwardly or backwardly.

Referring to FIGS. 2 and 3, the housing 1 is covered with the shield 3. The rectangle shaped shield 3 comprises two side walls 31, a top wall 32 and a back wall 33. Two windows 311 are respectively defined at middle of the two side walls for cooperating with the protrusions 112 formed on the housing 1 to maintain the shield 3 on the housing. A pair of soldering legs 312 respectively extend downwardly from a bottom edge of the side wall 31. At the front end of the top wall, a round opening 321 is defined to receive the connecting beam 52 of the clip 5.

In the present embodiment of the invention, the sleeve 4 made from metal material can provide a shielding function when the electrical connector is connecting with the counter connector (not shown), which can offer an excellent electrical performance. Besides, the sleeve 4 can connect with the third group of terminal 23 and act as a grounding path of the connector.

In other embodiments according with the present invention, the top wall 32 of the shield 3 can be a complete plate without a round opening 321 and the clip 5 is formed integrally and extending downwardly from the front edge of the top wall. Therefore, a grounding path also can be formed by the sleeve 4.

The present invention is not limited to the electrical connector mentioned above. This disclosure is illustrative only, changes may be made in detail, especially in matter of shapes, size, and arrangement of parts within the principles of the invention.

What is claimed is:

1. An electrical connector comprising:
an insulative housing defining therein a receiving cavity therein and a slot communicating with said receiving cavity;
at least one terminal arranged in the housing;
a sleeve retained in an inside of the receiving cavity; and
a clip inserted into the slot to lock the sleeve.

2. The electrical connector as described in claim 1, wherein the sleeve is made from metal material.

3. The electrical connector as described in claim 1, wherein a groove is defined on the sleeve and parts of the clip foist into the groove to retain the sleeve in the insulative housing.

4. The electrical connector as described in claim 3, wherein the clip is of an arch shape, and comprises a connecting beam and a pair of clipping portions connected by the connecting beam.

5. The electrical connector as described in claim 4, wherein the clipping portion is provided with tips at opposite sides thereof to fix the clip in the slot.

6. The electrical connector as described in claim 3, wherein the clip extends beyond a top face of the insulative housing partly.

7. The electrical connector as described in claim 3, wherein the groove is of an annular shape and defined along an outer perimeter surface of the sleeve.

8. The electrical connector as described in claim 1, wherein the sleeve is inserted into the receiving cavity along a mating direction while the clip is inserted into the slot along a direction vertical to the mating portion.

9. The electrical connector as described in claim 2, wherein a grounding terminal is provided to connect with the sleeve.

10. The electrical connector as described in claim 2, wherein a shield is provided to surround the housing and the clip extends integrally from the shield.

11. The electrical connector as described in claim 1, wherein said sleeve comprises an annular base portion and a blocking portion, the base portion is received in the receiving cavity and the blocking portion is positioned in front of the mating portion.

12. An electrical connector comprising:
an insulative housing defining a front cylindrical mating portion extending from a front face of a main body;
a plurality of contacts disposed in main body of the housing;
a colorful sleeve intimately attached to the housing in an axial direction; and
a clip attached to the housing in a radial direction perpendicular to said axial direction and locking the sleeve in position without movement relative to the housing along said axial direction.

13. The electrical connector as claimed in claim 12, wherein the sleeve is inserted inside of said sleeve.

14. The electrical connector as claimed in claim 13, wherein the housing defines a slot in the main body through which the clip locks said sleeve.

15. The electrical connector as claimed in claim 14, wherein said clip is received in the slot and includes a retention device to fasten to the main body.

16. The electrical connector as claimed in claim 12, wherein the main body is a rectangular block.

17. The electrical connector as claimed in claim 12, wherein said mating portion and the main body are partially overlapped with each other in said axial direction.

18. An electrical connector comprising:
an insulative housing defining a front cylindrical mating portion extending from a front face of a main body;
a plurality of contacts disposed in main body of the housing;
a colorful sleeve intimately attached to the housing; and
a clip attached on a circumference of the housing with a retention device to retain the clip to the housing and a locking device to lock the sleeve in position without movement relative to the housing along said axial direction.

19. The electrical connector as claimed in claim 18, wherein the sleeve is inserted inside of said sleeve.
